(19) United States
(12) Patent Application Publication
(10) Pub. No.: US 2017/0331912 A1
(43) Pub. Date: Nov. 16, 2017

(54) MULTI-ACCOUNT LOGIN AND COMMUNICATION

(71) Applicant: Alibaba Group Holding Limited, Grand Cayman (KY)

(72) Inventors: Xiang JIANG, Zhejiang (CN); Jun WU, Zhejiang (CN)

(73) Assignee: Alibaba Group Holding Limited

(21) Appl. No.: 15/669,752

(22) Filed: Aug. 4, 2017

Related U.S. Application Data
(63) Continuation of application No. PCT/CN2016/072778, filed on Jan. 29, 2016.

(30) Foreign Application Priority Data
Feb. 5, 2015 (CN) 201510062182.X

(51) Int. Cl. H04L 29/08; H04L 12/58

(52) U.S. Cl. CPC H04L 67/26; H04L 67/36; H04L 51/04; H04L 67/306

(57) ABSTRACT

The present disclosure relates to the field of communications, and discloses a multi-account login and communication method, apparatus, and a mobile terminal. The login method includes: receiving, by a plurality of activity components respectively, information of accounts that need to be online simultaneously; transferring, by the activity components respectively, the information of accounts to corresponding service components in different processes via binding instances; and performing, by the service components respectively, login according to the information of accounts. Example embodiments of the present disclosure configure the service components in different service processes, and bind the service processes to processes where the corresponding activity components are located by using a binding mechanism. In this way, each account is bound to a corresponding service process through the binding mechanism, and simultaneous login of multiple accounts is implemented by using independence between the processes.

### CROSS REFERENCE TO RELATED PATENT APPLICATIONS

This application claims priority to and is a continuation of PCT Patent Application No. PCT/CN2016/072778, filed on 29 Jan. 2016, which claims priority to Chinese Patent Application No. 201510062182.X, filed on 5 Feb. 2015, entitled “MULTI-ACCOUNT LOGIN AND COMMUNICATION METHOD, APPARATUS, AND MOBILE TERMINAL,” which are hereby incorporated by reference in their entirety.

### TECHNICAL FIELD

The present disclosure relates to the field of communications and, in particular, to a multi-account login and communication method, apparatus, and a mobile terminal.

### BACKGROUND

With the development of IM (instant messaging) products, user demands are increasing. For example, users expect that IM products can support multiple accounts to be online simultaneously for transmitting and receiving messages. However, most of the existing IM products only support single-account login, and the current account needs to be logged out before the login of other accounts. How to quickly upgrade a single-account support version to a multi-account support version has become a problem that many IM development engineers need to solve.

To implement multiple accounts online simultaneously to meet communication needs in different usage scenarios, developers have three implementation methods:

1. Abandon existing IM solutions or socket communication framework, and write their own IM logics.

2. Push providers of the current IM solution or providers of the socket communication framework to provide multi-account support.

3. If the IM solution is provided by itself, reconstruct a communication layer to enhance the multi-account support.

For the first manner, because the writing of communication logics on an IM underlying socket layer is complicated and development of most of the current IM products adopts the existing IM solutions (such as Huanxin or Pro Plus Communication Cloud) or ready-made socket layer communication framework (such as mina), it is difficult to rewrite IM logics. Although there are some IM products that use their own IM underlying function, such a manner has an overly high cost. For the second manner, a significant amount of time is needed to require the providers of the current IM solution or the providers of the socket communication framework to provide the multi-account support at the same time, so this manner is not suitable for the case where there is an urgent need of the multi-account support, as it is quite possible to miss the timing for promotion and lose a large number of users. For the third manner, the core communication layers of the IM products are generally relatively fixed, and can hardly be altered after realization, and generally, alteration of the communication layer is a complicated work, which requires a high labor cost; at the same time, reconstruction of the communication layer is also faces unknown risks such as functional failures after the reconstruction, and it is difficult to meet the needs of rapid development of projects.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

An objective of the present disclosure is to provide a multi-account login and communication method, apparatus and a mobile terminal, which conveniently achieves login or communication of multiple accounts in a same instant messaging client terminal.

The present disclosure provides a method comprising:

presenting a plurality of interfaces for log in;

receiving information of a plurality of accounts from the plurality of interfaces respectively; and

establishing a plurality of connections to a server for the plurality of accounts respectively so that the plurality of accounts are online simultaneously.

For example, a respective connection of the plurality of connections is a socket connection.

For example, the presenting the plurality of interfaces includes presenting, by a plurality of activity components, the plurality of interfaces.

For example, the receiving information of the plurality of accounts from the plurality of interfaces respectively includes:

receiving, by the plurality of activity components respectively, the information of the plurality of accounts;

For example, the establishing the plurality of connections to the server for the plurality of accounts respectively includes:

transferring, by the plurality of activity components respectively, the information of the plurality of accounts to corresponding service components in different processes via binding instances; and

performing, by the service components respectively, login according to the information of the accounts.

For example, the performing, by the service components respectively, login according to the information of the accounts includes:

connecting, by a respective service component of the service components, a respective socket connection to the server for a respective account.

For example, the method further comprises:

before transferring, by the plurality of activity components respectively, the information of the plurality of accounts to the corresponding service components in different processes via binding instances,

configuring the service components according to a number of the plurality of accounts.

For example, the configuring the service components according to a number of the plurality accounts includes:

selecting a service component and multiple sub-classes of the service components according to the number of the plurality of the account, a number of the service component and the multiple sub-classes of the service component equal to the number of the plurality of the accounts.

For example, the sub-classes inherit null-classes of the service component.

For example, the method further comprises:

before transferring, by the plurality of activity components respectively, the information of the plurality of the accounts to the corresponding service components in different processes via the binding instances,

binding processes where the plurality of activity components are located to service processes where the service components are located respectively; and

feeding back, by the service components, the corresponding binding instances to the plurality of activity components respectively.

For example, the method further comprises:

before transferring, by the plurality of activity components respectively, the information of the plurality of the accounts to the corresponding service components in different processes via the binding instances, implementing, in a configuration file of an Android system, configuring the service components in different service processes.

For example, the method further comprises:

invoking, by a respective activity component of the plurality of activity components, a respective service component to perform a respective communication operation via a respective binding instance.

For example, the respective communication operation includes one or more of:

invoking, by the respective activity component, the respective service component to send a message to the server via the respective binding instance;

feeding back, by the respective service component, a received message to the respective activity components via the binding instance; and

invoking, by the respective activity component, the respective service component to log out of the server via the respective binding instance.

For example, the method further comprises:

after invoking, by the respective activity component, the respective service component to send the message to the server via the respective binding instance,
feeding back, by the respective service component, a result of the respective communication operation to the respective activity component via the respective binding instance.

For example, the invoking, by the respective activity component, the respective service component to send the message to the server via the respective binding instance includes:

invoking, by the respective activity components, the respective service components to log out of the server via the respective binding instance; and

removing, by the respective activity component, the respective binding instance with the respective service component.

The present disclosure also provides an apparatus comprising:

one or more processors; and

one or more memories stored thereon computer-readable instructions that, when executed by the one or more processor, cause the one or more processors to perform acts comprising:
receiving, by a plurality of activity components respectively, information of a plurality of accounts to be online simultaneously;
transferring, by the plurality of activity components respectively, the information of accounts to corresponding service components in different processes via binding instances; and
performing, by the service components respectively, login according to the information of accounts.

For example, the acts further comprise:

configuring a number of multiple sub-classes of a respective service components according to a number of the accounts to be online simultaneously, wherein the sub-classes inherit null-classes of the respective service components.

For example, the acts further comprise:

binding processes where the plurality of activity components are located to service processes where the service components are located respectively; and

feeding back, by the service components, the corresponding binding instances to the activity components respectively.

For example, the acts further comprise:

invoke, by a respective activity component, a respective service component to perform a respective communication operation via a respective binding instance.

The present disclosure also provides one or more memories stored thereon computer-readable instructions that, when executed by one or more processor, cause the one or more processors to perform acts comprising:

presenting, by a plurality of activity components, a plurality of interfaces for log in;

receiving, by the plurality of activity components, information of a plurality of accounts from the plurality of interfaces respectively;

transferring, by the plurality of activity components respectively, the information of the plurality of accounts to corresponding service components in different processes via binding instances; and

performing, by the service components respectively, login according to the information of the accounts.

In order to solve the above technical problem, implementations of the present disclosure also disclose a multi-account login method, including:

receiving, by a plurality of activity components respectively, information of accounts that need to be online simultaneously;

transferring, by the plurality of activity components respectively, the information of accounts to corresponding service components in different processes via binding instances; and

performing, by the service components respectively, login according to the information of accounts.

The implementations of the present disclosure further disclose a multi-account communication method, including:

steps of the above multi-account login method; and
invoking, by the activity components, the service components to perform a communication operation via the binding instances.

The implementations of the present disclosure further disclose a multi-account login apparatus, including:

a receiving module configured to implement receiving, by a plurality of activity components respectively, information of accounts that need to be online simultaneously;

an invoking module configured to implement transferring, by the activity components respectively, the information of accounts to corresponding service components in different processes via binding instances; and

a login module configured to implement performing, by the service components respectively, login according to the information of accounts.

The implementations of the present disclosure further disclose a multi-account communication apparatus, including:

the above multi-account login apparatus; and

a communication operation module configured to implement invoking, by the activity components, the service components to perform a communication operation via the binding instances.

In addition, an example embodiment of the present disclosure further provides a mobile terminal, including the above apparatus.

Compared with the conventional techniques, the present disclosure has the following major differences and effects: in the example embodiments of the present disclosure, the activity components respectively invoke the corresponding service components in different processes to perform login via the binding instances. In this way, each account is bound to a corresponding service process through a binding mechanism, and simultaneous login and communication of multiple accounts are implemented by using independence between processes.

The implementations of the present disclosure may upgrade the existing single-account instant messaging client terminal to have a function of simultaneous online login and communication of multiple accounts based on the existing IM solution or socket communication frame. The implementation is simple, the development cycle is short, and the risk is small, thereby satisfying the requirement that multiple accounts are online simultaneously.

### BRIEF DESCRIPTION OF THE DRAWINGS

The accompanying drawings described herein are used to provide further understanding of the present disclosure. Example embodiments of the present disclosure and description thereof are intended to explain the present disclosure and do not impose any improper limitation to the present disclosure. In the accompanying drawings:

FIG. 1 is a schematic flowchart of a multi-account login method according to an implementation of the present disclosure;

FIG. 2 is a flowchart of configuring an instant messaging client terminal in a multi-account login method according to an implementation of the present disclosure;

FIG. 3 is a schematic flowchart of a multi-account communication method according to an implementation of the present disclosure;

FIG. 4 is a flowchart of logout of a server in a multi-account communication method according to an implementation of the present disclosure;

FIG. 5 is a schematic structural diagram of a multi-account login apparatus according to an implementation of the present disclosure;

FIG. 6 is a schematic structural diagram of another multi-account login apparatus according to an implementation of the present disclosure;

FIG. 7 is a schematic structural diagram of a multi-account login apparatus according to an implementation of the present disclosure; and

FIG. 8 is a schematic structural diagram of a multi-account login apparatus according to an implementation of the present disclosure.

### DETAILED DESCRIPTION

In the following description, in order to help readers better understand the present disclosure, many technical details are provided. However, those of ordinary skill in the art may understand that the technical solutions claimed by each claim of the present application may be implemented even without having all of the technical details and various variations and modifications below.

In order to make the objectives, technical solutions and advantages of the present disclosure clearer, the implementations of the present disclosure are further described below in detail with reference to the accompanying drawings.

In the implementations of the present disclosure, “activity component” refers to an Activity component, which is one of the common components in Android components. The Activity component is an application component, which provides an interactive area on a screen that is used by a user for interaction to accomplish a task or to implement a function. “Service component” refers to a Service component, which is also one of the common components in the Android components, and is used to process some time-consuming logics in the background, or perform tasks that require a long-time running. If necessary, even if a program exits, the Service component may still continue to maintain a running state in the background. “Binding” refers to a Binder. In an Android system, each application contains some Activity components and Service components, and these Activity components and Service components may be running in a same progress, and may also be running in different processes. For the components running in different processes, the Android system may adopt a Binder mechanism to perform interprocess communication. For example, the Binder may implement communication between the Activity component in a master process and the service process running in the Service process.

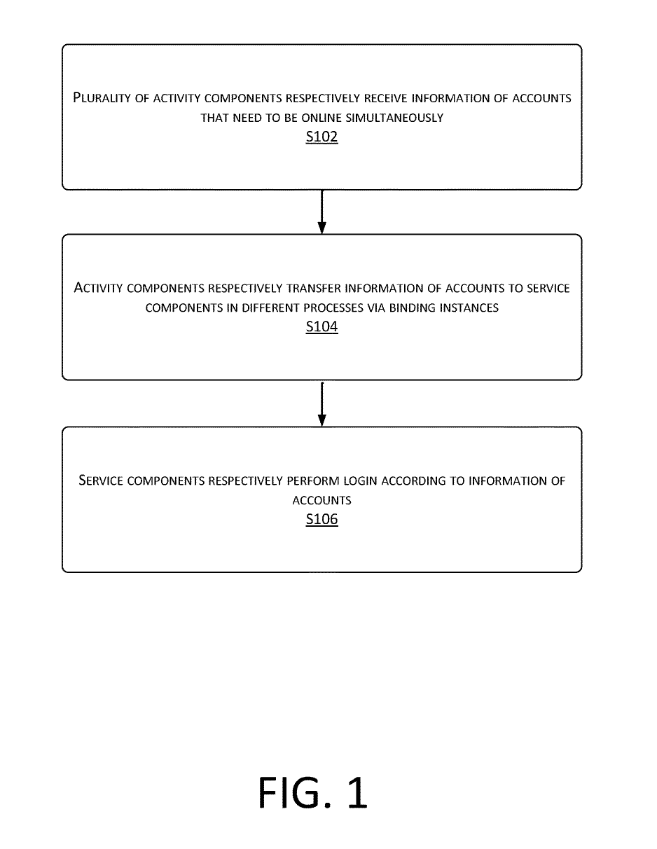

Referring to FIG. 1, FIG. 1 is a schematic flowchart of a multi-account login method according to an implementation of the present disclosure. The implementation shown in FIG. 1 includes steps S102-S106.

In step S102, a plurality of activity components respectively receive information of accounts that need to be online simultaneously.

Afterwards, the process proceeds to step S104, in which the activity components respectively transfer the information of accounts to service components in different processes via binding instances.

Then the process proceeds to step S106, in which the service components respectively perform login according to the information of accounts, thereby achieving the purpose that for being o multiple accounts are simultaneous logged in and online.

Specifically, the activity components are configured to provide interaction interfaces corresponding to the information of accounts, and a user may input the information of accounts that need to be online simultaneously in the interaction interfaces, such as a user name and a password. The instant messaging client terminal may include a plurality of activity components, which are loosely bound to one another. Each activity component, for executing different behaviors, can start another activity component. When a new activity component is started, the previous activity component is ceased, but the Android system retains the activity component to the top in a stack (a back stack), and its corresponding interaction interface loses the user's focus. The back stack follows a basic “last-in first-out” queue mechanism, so when the user completes work with the current activity component and switches the interaction interface, the previous activity may pop up from the back stack, and restore to the previous state.

In some implementations, the interaction interfaces for the user to receiving the information of accounts may be set on different pages respectively (the pages may also be provided by the activity components), and may also be integrated on the same page. The interaction interfaces for receiving the information of accounts are one-to-one corresponding to the activity components. Therefore, after the user inputs information of accounts to an interaction interface, an activity component may obtain the information of accounts inputted by the user.

For example, if three accounts need to be logged in, three activity components are required to provide three interaction interfaces for login. The three interaction interfaces may be respectively configured on different pages, and may also be configured on one page. The activity components acquire the information of accounts inputted by the user from the corresponding interaction interfaces.

In another aspect, each service component may maintain a long connection with a server via a socket connection. Each socket connection has a locally unique socket number, so that, the instant messaging client terminal may implement multi-account login or communication by using a plurality of socket connections. In this way, a plurality of service components may log in to the server for implementing simultaneous login of multiple accounts via the corresponding long socket connections.

If the activity components receive information of accounts via corresponding interaction interfaces, the information of accounts is transferred to corresponding service components via binding instances. The service components send the information of accounts to the server for login via the established long socket connections.

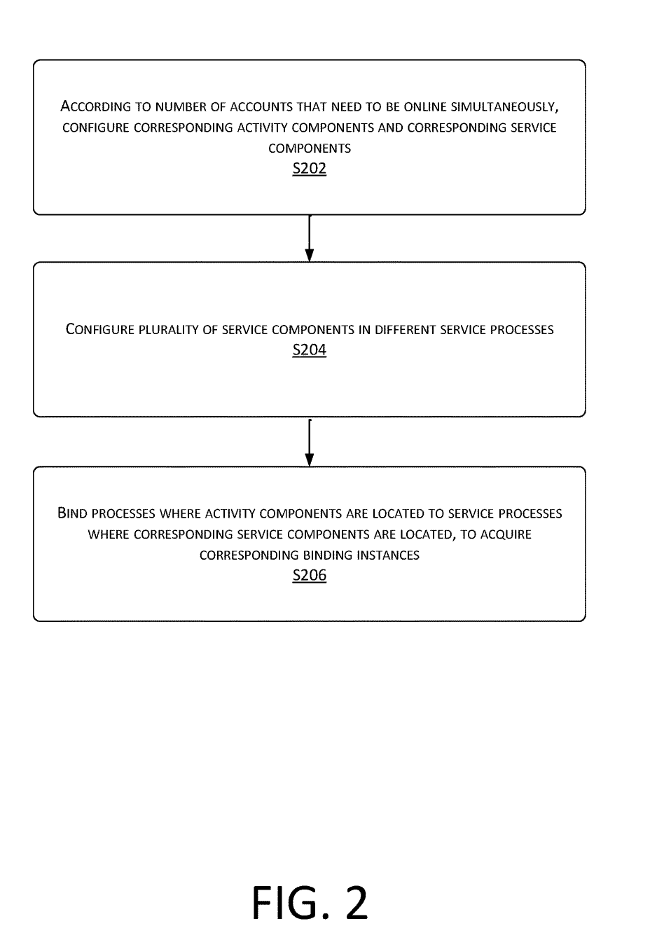

In order to implement multi-account login, it is required to configure the instant messaging client terminal before use. Referring to FIG. 2, FIG. 2 is a flowchart of configuring an instant messaging client terminal in a multi-account login method according to an implementation of the present disclosure. The configuring process includes steps S202-S206.

In step S202, according to the number of accounts that need to be online simultaneously, corresponding activity components and corresponding service components are configured. For example, according to the number of accounts that need to be online simultaneously, corresponding activity components are configured, each activity component providing one interaction interface for inputting information of the accounts. In addition, according to the number of accounts that need to be online simultaneously, the numbers of the service components and sub-classes thereof are selected. For example, if three accounts need to be online simultaneously, one service component S₀ and two sub-classes of the service component S₀, namely a service component S₁ and a service component S₂, need to be implemented, the sub-classes inheriting null-classes of the service component S₀. In this way, three activity components may be implemented, namely the service component S₀, the service component S₁, and the service component S₂, to satisfy the need that three accounts are online simultaneously. In the process of login, the number of accounts online simultaneously is less than or equal to the number of the configured service components. For example, in an implementation in which three service components are configured, the number of accounts logged in simultaneously may be 1, 2, or 3. During use, a user may select the number of accounts that are online simultaneously according to actual needs, the number being not necessarily the same as the number of the service components.

In step S204, a plurality of the service components are configured in different service processes.

In a specific implementation process, for example, in an AndroidManifest configuration file in an Android system, the service component S₀ may be configured in a service process, the service component S₁ is configured in a service1 process, and the service component S₂ is configured in a service2 process.

In Step S206, processes where the activity components are located are bound to service processes where the corresponding service components are located, to acquire corresponding binding instances (a Binder). When the activity components are bound to the service components, if the service components have not established a socket connection with a server, the service components firstly establish the socket connection with the server. If the activity components receive information of accounts, the activity components transfer the information of accounts to the service components via binding instances, and the service components log in to the server via the socket connection.

Specifically, the processes where the activity components are located are bound to the service processes where the corresponding service components are located. Upon completion of binding, the service components feedback the corresponding binding instances to the activity components (i.e., the Binder). In this way, the activity components may respectively invoke the service components to log in to the server via the binding instances. For example, in some implementations, when three accounts need to be logged in simultaneously, an activity component A₀, an activity component A₁, and an activity component A₂ provide three interaction interfaces for respectively receiving information of accounts inputted by a user. The process where the activity component A₀ (i.e., the Activity component) is located is bound to the Service process where the service component S₀ is located via a Binder mechanism. At the same time, the process where the activity component A₁ is located is bound to the Service1 process where the service component S₁ is located, and the process where the activity component A₂ is located is bound to the Service2 process where the service component S₂ is located. In this way, the process where the activity component A₀ is located acquires a corresponding binding instance B₀ through the Service process where the service component S₀ is located; the process where the activity component A₁ is located acquires a corresponding binding instance B₁ through the Service1 process where the service component S₁ is located; and the process where the activity component A₂ is located acquires a corresponding binding instance B₂ through the Service2 process where the service component S₂ is located. Wherein, the Service process, the Service1 process, and the Service2 process are respectively different service processes.

Therefore, the activity component A₀, the activity component A₁, and the activity component A₂ may invoke the corresponding service component S₀, service component S₁, and service component S₂ to perform login using different accounts via the binding instance B₀, the binding instance B₁, and the binding instance B₂ respectively. For example, if it is assumed that a user needs to log in three accounts simultaneously: a first account, a second account, and a third account, after receiving the first account via a corresponding interaction interface, the activity component A₀ invokes the corresponding service component S₀ to log in the first account via the binding instance B₀; after receiving the second account via a corresponding interaction interface, the activity component A₁ invokes the corresponding service component S₁ via the binding instance B₁ to log in the second account; and after receiving the third account via a corresponding interaction interface, the activity component A₂ invokes the corresponding service component S₂ to log in the third account via the binding instance B₂, thereby achieving simultaneous login of three accounts.

Because the service component S₀, the service component S₁, and the service component S₂ are running in different processes and one process includes one Socket connection, a function that multiple accounts are logged in and online simultaneously can be implemented. In the implementation shown in FIG. 1, when invoking the corresponding binding instance B₀, the activity component A₀ may invoke a login method of the binding instance B₀, and the binding instance B₀ invokes a login operation of the corresponding service component S₀ to log in the corresponding account to the server. After successful login, the binding instance B₀ may also return a login result to the activity component A₀ through a callback function set by the activity component A₀. Likewise, the activity component A₁ and the activity component A₁ may also log in the corresponding account by correspondingly invoking the login method of the corresponding binding instance B₁ or binding instance B₂, thereby achieving multi-account login.

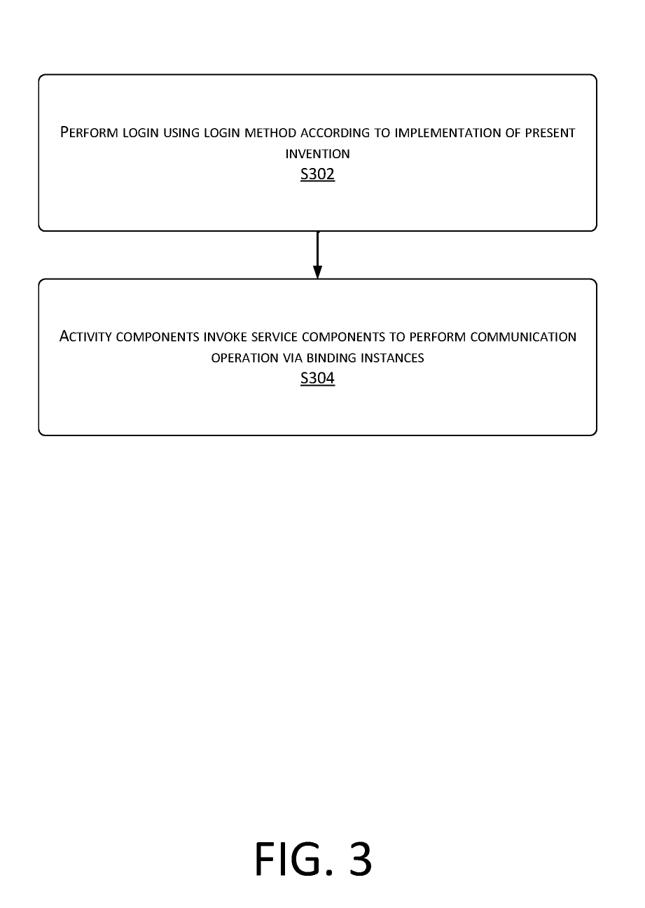

In addition, an example embodiment of the present disclosure further discloses a multi-account communication method. Referring to FIG. 3, the method further includes step S304 after performing login using the login method according to the implementation shown in FIG. 1 (step S302).

In step S304, the activity components perform a communication operation via corresponding binding instances. After the service components establish a socket connection, the activity components register a new message and receive monitoring via binding instances. In this way, if the service components receive a message from a server, the activity components may be notified about the message via the binding instances. Likewise, if the service components receive a request for sending a message initiated by the activity components, the service components send the message to the server through the socket connection.

In some implementations, the above “communication operation” includes, but is not limited to, invoking, by the activity components, the service components to send a message to a server via the binding instances, feeding back, by the service components, the received message to the activity components via the binding instances, and invoking, by the activity components, the service components to log out of the server via the binding instances. For example, in the implementation where the activity components invoke the service components to send a message to a server via the binding instances, the activity components invoke a sendMessage method of the binding instances, invoke the service components to trigger a message sending operation, and transfer the message to the server. After the message is sent successfully, the service components transfer a message sending result to the activity components by using a callback set by the activity components via the binding instances. For another example, in the implementation where the service components feedback the received message to the activity components via the binding instances, the service components may receive a message sent by others, and pass through content of the message to the activity components via the binding instances and the callback set by the activity components.

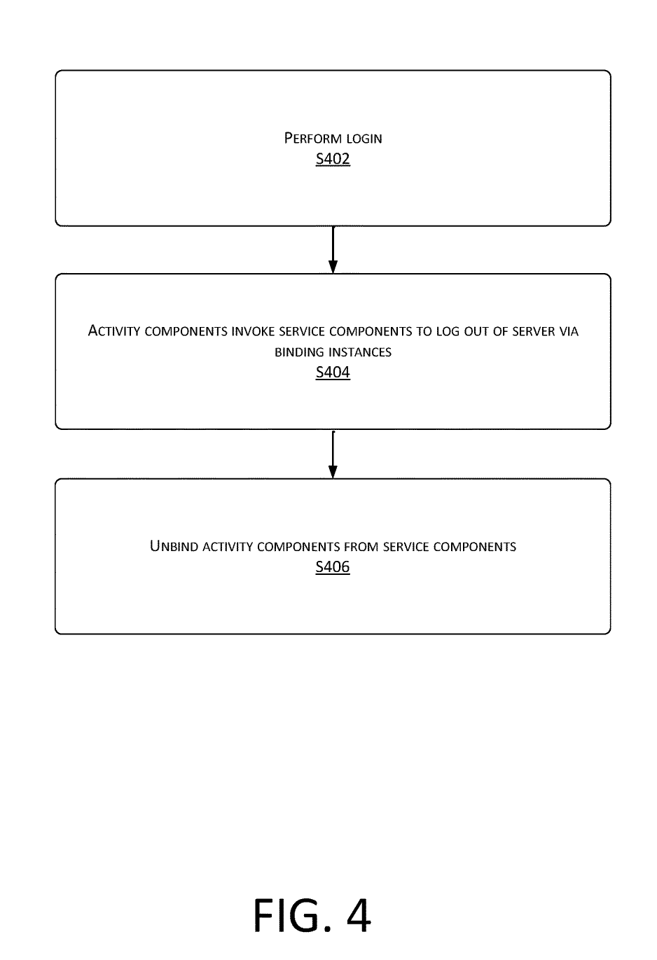

In some other implementations, referring to FIG. 4, FIG. 4 is a flowchart of logout of a server in a multi-account communication method according to an implementation of the present disclosure. The implementation shown in FIG. 4 includes steps S402-S406. After the login using the implementation shown in FIG. 1 in step S402, the process proceeds to steps S404 and S406.

In Step S404, the activity components may invoke the service components to log out of the server via the binding instances. Then, in step S406, the activity components are unbound from the service components. For example, at the end of the scenario of instant messaging, the activity components may invoke a logout method of the binding instances, and the binding instances invoke a logout operation of the service components to log out of the server. After successful logout, the binding instances may return a logout result to the activity components through a callback set by the activity components. Finally, the activity components are unbound from the service components.

In some other existing implementations, the instant messaging client terminal may have encapsulated basic logics such as login, message receiving and transmitting, and long socket connections in a service component. Usually, the binding property of the service components decides that these existing solutions are all cross-process. Therefore, the service where the service components are located is bound to the activity components to implement the function of supporting simultaneous login of multiple accounts.

All method implementations of the present disclosure can all be implemented by means of software, hardware, firmware, or the like. No matter whether the present disclosure is implemented by means of software, hardware, or firmware, an instruction code can be stored in any type of computer accessible memory (e.g., permanent or modifiable, volatile or non-volatile, solid-state or non-solid-state, fixed or replaceable medium, and so on). Similarly, the memory may be, for example, a Programmable Array Logic (PAL), a Random-Access Memory (RAM), a Programmable Read Only Memory (PROM), a Read-Only Memory (ROM), an Electrically Erasable Programmable ROM (EEPROM), a magnetic disk, an optical disc, a Digital Versatile Disc (DVD), and so on.

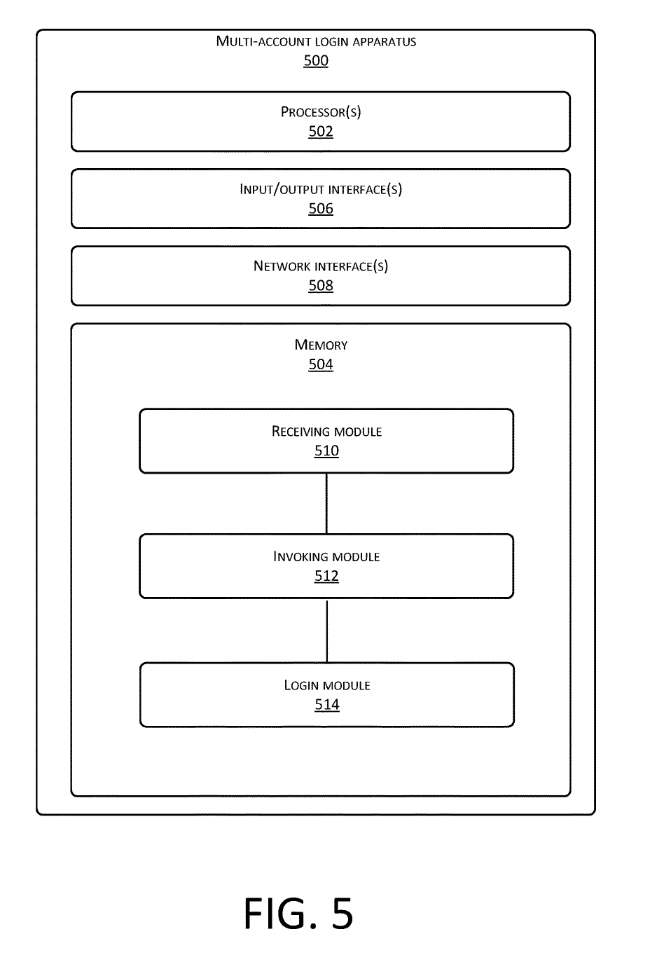

An implementation of the present disclosure further relates to a multi-account login apparatus. FIG. 5 is a schematic structural diagram of a multi-account login apparatus 500 according to an implementation of the present disclosure. As shown in FIG. 5, the multi-account login apparatus 500 includes one or more processor(s) 502 or data processing unit(s) and memory 504. The multi-account login apparatus 500 may further include one or more input/output interface(s) 506 and one or more network interface(s) 508. The memory 504 is an example of computer readable media.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

The memory 504 may store therein a plurality of modules or units including a receiving module 510, an invoking module 512, and a login module 514.

Wherein, the receiving module 510 is configured to implement receiving, by a plurality of activity components respectively, information of accounts that need to be online simultaneously. The invoking module 512 is configured to implement transferring, by the activity components respectively, the information of accounts to corresponding service components in different processes via binding instances. The login module 514 is configured to implement performing, by the service components respectively, login according to the information of accounts.

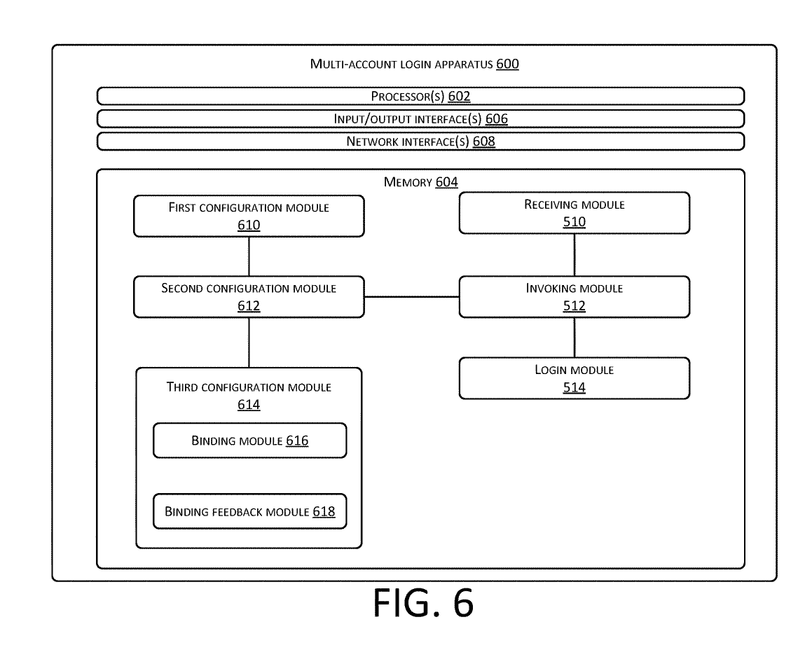

Referring to FIG. 6, FIG. 6 is a schematic structural diagram of another multi-account login apparatus 600 according to an example embodiment of the present disclosure. As shown in FIG. 6, the multi-account login apparatus 600 includes one or more processor(s) 602 or data processing unit(s) and memory 604. The multi-account login apparatus 600 may further include one or more input/output interface(s) 606 and one or more network interface(s) 608. The memory 604 is an example of computer readable media.

The memory 604 may store therein a plurality of modules or units including, in addition to the receiving module 510, the invoking module 512, and the login module 514 in the implementation shown in FIG. 5, a first configuration module 610, a second configuration module 612, and a third configuration module 614.

Wherein, the first configuration module 610 is configured to configure the service components and multiple sub-classes of the service components according to the number of information of accounts that need to be online simultaneously, wherein the sub-classes inherit null-classes of the service components. The second configuration module 612 is configured to implement, in a configuration file of an Android system, configuring a plurality of service components in different service processes. The third configuration module 614 includes a binding module 616 and a binding feedback module 618. The binding module 616 is configured to bind the processes where the activity components are located to the service processes where the corresponding service components are located respectively. The binding feedback module 618 is configured to implement feeding back, by the service components, the corresponding binding instances to the activity components.

The above implementation is an apparatus implementation corresponding to the login method implementation, and this implementation may be implemented in cooperation with the login method implementation. The relevant technical details mentioned in the login method implementation are still effective in this implementation, which thus are not described here for reducing repetitions. Correspondingly, the relevant technical details mentioned in this implementation may also be applied to the login method implementation.

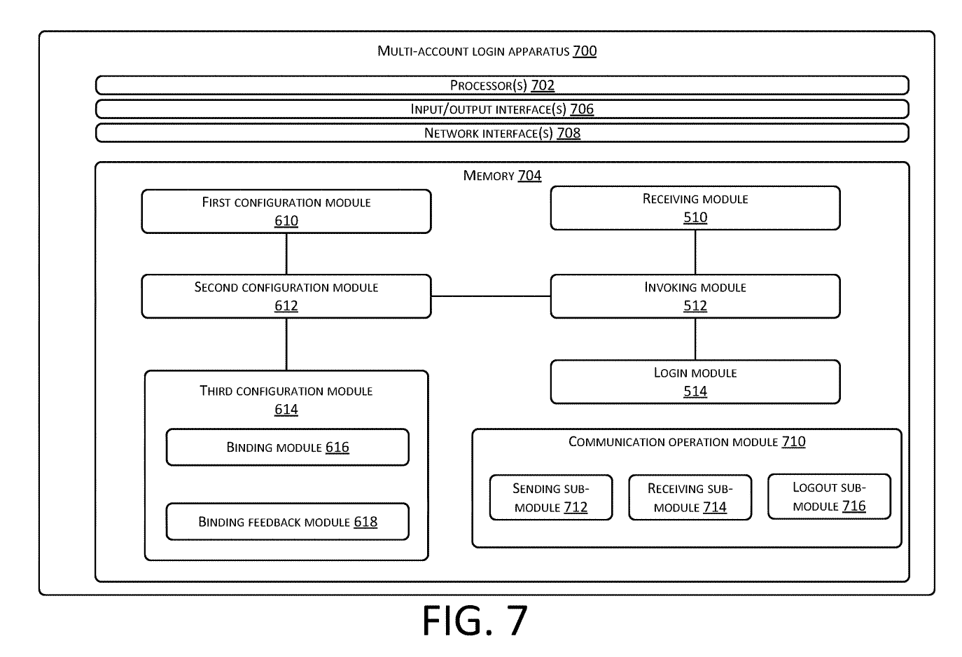

An implementation of the present disclosure further relates to a multi-account communication apparatus. FIG. 7 is a schematic structural diagram of a multi-account login apparatus 700 according to the implementation. As shown in FIG. 7, the multi-account login apparatus 700 includes one or more processor(s) 702 or data processing unit(s) and memory 704. The multi-account login apparatus 700 may further include one or more input/output interface(s) 706 and one or more network interface(s) 708. The memory 704 is an example of computer readable media.

The memory 704 may store therein a plurality of modules or units including a communication operation module 710, in addition to the receiving module 510, the invoking module 512, the login module 514, the first configuration module 610, the second configuration module 612, and the third configuration module 614 as shown in FIG. 6.

The communication operation module 710 is configured to implement invoking, by the activity components, the service components to perform a communication operation via corresponding binding instances. The communication operation module 710 includes, but is not limited to, a sending sub-module 712 configured to invoke, by the activity components, the service components to send a message to a server via the binding instances, a receiving sub-module 714 configured to feedback, by the service components, the received message to the activity components via the binding instances, and a logout sub-module 716 configured to invoke, by the activity components, the service components to log out of the server via the binding instances. In some implementations, the communication apparatus further includes a result feedback module configured to implement feeding back, by the service components, a result of the communication operation to the activity components via the binding instances.

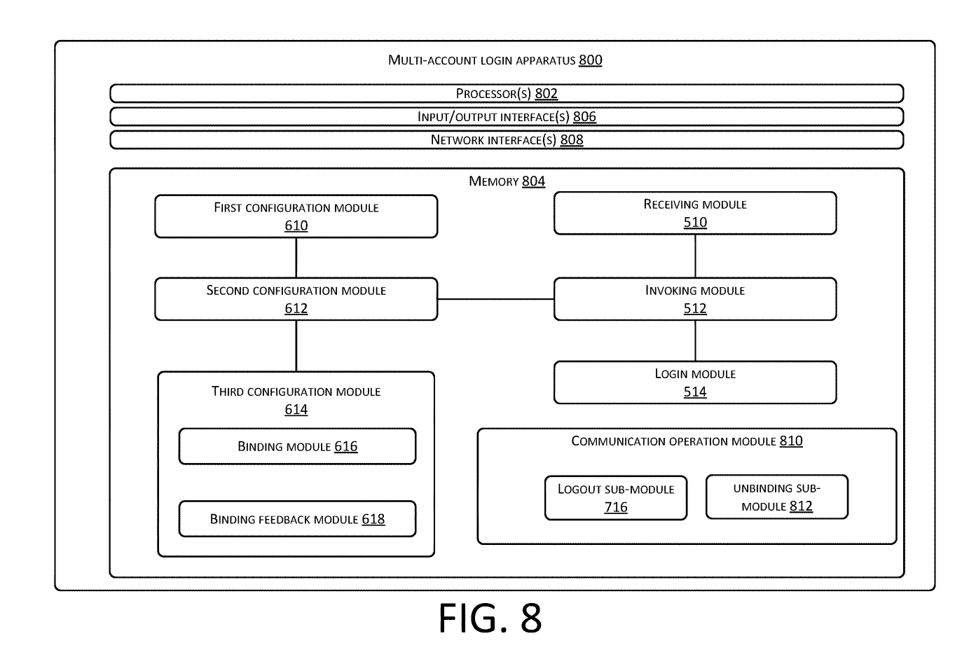

In some other implementations, referring to FIG. 8, a multi-account login apparatus 800 includes one or more processor(s) 802 or data processing unit(s) and memory 804. The multi-account login apparatus 800 may further include one or more input/output interface(s) 806 and one or more network interface(s) 808. The memory 804 is an example of computer readable media. The memory 804 may store therein a plurality of modules or units including a communication operation module 810, the receiving module 510, the invoking module 512, the login module 514, the first configuration module 610, the second configuration module 612, and the third configuration module 614.

The communication operation module 810 includes a logout sub-module 716 and an unbinding sub-module 812. Wherein, the logout sub-module 716 is configured to implement invoking, by the activity components, the service components to log out of the server via the binding instances. The unbinding sub-module 812 is configured to implement removing, by the activity component, the binding with the service component.

The implementation shown in FIG. 4 is a method implementation corresponding to this implementation, and this implementation may be implemented in cooperation with the implementation shown in FIG. 4. The relevant technical details mentioned in the implementation shown in FIG. 4 are still effective in this implementation, which thus are not described here for reducing repetitions. Correspondingly, the relevant technical details mentioned in this implementation may also be applied to the implementation shown in FIG. 4.

In addition, the present disclosure further relates to a mobile terminal, which includes an apparatus in any one implementation shown in FIG. 5 to FIG. 8.

It should be noted that each unit mentioned in each device implementation of the present disclosure is a logic unit. Physically, a logic unit may be a physical unit, may also be a part of a physical unit, and may be further implemented with a combination of a plurality of physical units. Physical implementation manners of the logic units per se are not most important, but a combination of functions implemented by the logic units is the key to solving the technical problem raised in the present disclosure. In addition, in order to highlight the innovative part of the present disclosure, each device implementation of the present disclosure does not introduce units not closely related to the technical problem raised in the present disclosure, but this does not indicate that the device implementation does not include other units.

It should be noted that, in the claims and specification of the patent, the relational terms such as first and second are merely used to distinguish one entity or operation from another entity or operation, but may not necessarily require or imply that the entities or operations have any such an actual relation or order therebetween. Moreover, the terms “include” and “comprise” or any other variations intend to cover non-exclusive inclusion, so that processes, methods, articles or devices including a series of elements not only include the elements, but also include other elements not explicitly listed, or also include inherent elements of the processes, methods, articles or devices. In the absence of more limitations, the elements defined by the expression “including one” do not exclude that the processes, methods, articles or devices including the elements also have other identical elements.

Although the present disclosure has been illustrated and described with reference to some preferred implementations of the present disclosure, those of ordinary skill in the art should understand that various changes can be made to the present disclosure in the form and details without departing from the spirit and scope of the present disclosure.

What is claimed is:

1. A method comprising:
presenting a plurality of interfaces for log in;
receiving information of a plurality of accounts from the plurality of interfaces respectively; and
establishing a plurality of connections to a server for the plurality of accounts respectively so that the plurality of accounts are online simultaneously.

2. The method of claim 1, wherein a respective connection of the plurality of connections is a socket connection.

3. The method of claim 1, wherein the presenting the plurality of interfaces includes presenting, by a plurality of activity components, the plurality of interfaces.

4. The method of claim 3, wherein the receiving information of the plurality of accounts from the plurality of interfaces respectively includes:
receiving, by the plurality of activity components respectively, the information of the plurality of accounts;

5. The method of claim 4, wherein the establishing the plurality of connections to the server for the plurality of accounts respectively includes:
transferring, by the plurality of activity components respectively, the information of the plurality of accounts to corresponding service components in different processes via binding instances; and
performing, by the service components respectively, login according to the information of the accounts.

6. The method of claim 5, wherein the performing, by the service components respectively, login according to the information of the accounts includes:
connecting, by a respective service component of the service components, a respective socket connection to the server for a respective account.

7. The method of claim 5, further comprising:
before transferring, by the plurality of activity components respectively, the information of the plurality of accounts to the corresponding service components in different processes via binding instances,
configuring the service components according to a number of the plurality of accounts.

8. The method of claim 7, wherein the configuring the service components according to a number of the plurality accounts includes:
selecting a service component and multiple sub-classes of the service components according to the number of the plurality of the account, a number of the service component and the multiple sub-classes of the service component equal to the number of the plurality of the accounts.

9. The method of claim 8, wherein the sub-classes inherit null-classes of the service component.

10. The method of claim 5, further comprising:
before transferring, by the plurality of activity components respectively, the information of the plurality of the accounts to the corresponding service components in different processes via the binding instances,
binding processes where the plurality of activity components are located to service processes where the service components are located respectively; and
feeding back, by the service components, the corresponding binding instances to the plurality of activity components respectively.

11. The method of claim 5, further comprising:
before transferring, by the plurality of activity components respectively, the information of the plurality of the accounts to the corresponding service components in different processes via the binding instances,
implementing, in a configuration file of an Android system, configuring the service components in different service processes.

12. The method of claim 5, further comprising:
invoking, by a respective activity component of the plurality of activity components, a respective service component to perform a respective communication operation via a respective binding instance.

13. The method of claim 12, wherein the respective communication operation includes one or more of:
invoking, by the respective activity component, the respective service component to send a message to the server via the respective binding instance;
feeding back, by the respective service component, a received message to the respective activity components via the binding instance; and
invoking, by the respective activity component, the respective service component to log out of the server via the respective binding instance.

14. The method of claim 13, further comprising:
after invoking, by the respective activity component, the respective service component to send the message to the server via the respective binding instance,
feeding back, by the respective service component, a result of the respective communication operation to the respective activity component via the respective binding instance.

15. The method of claim 13, wherein the invoking, by the respective activity component, the respective service component to send the message to the server via the respective binding instance includes:
invoking, by the respective activity components, the respective service components to log out of the server via the respective binding instance; and
removing, by the respective activity component, the respective binding instance with the respective service component.

16. An apparatus comprising:
one or more processors; and
one or more memories stored thereon computer-readable instructions that, when executed by the one or more processor, cause the one or more processors to perform acts comprising:
receiving, by a plurality of activity components respectively, information of a plurality of accounts to be online simultaneously;
transferring, by the plurality of activity components respectively, the information of accounts to corresponding service components in different processes via binding instances; and
performing, by the service components respectively, login according to the information of accounts.

17. The apparatus of claim 16, wherein the acts further comprise:
configuring a number of multiple sub-classes of a respective service components according to a number of the accounts to be online simultaneously, wherein the sub-classes inherit null-classes of the respective service components.

18. The apparatus of claim 16, wherein the acts further comprise:
binding processes where the plurality of activity components are located to service processes where the service components are located respectively; and
feeding back, by the service components, the corresponding binding instances to the activity components respectively.

19. The apparatus of claim 16, wherein the acts further comprise:
invoke, by a respective activity component, a respective service component to perform a respective communication operation via a respective binding instance.

20. One or more memories stored thereon computer-readable instructions that, when executed by one or more processor, cause the one or more processors to perform acts comprising:
presenting, by a plurality of activity components, a plurality of interfaces for log in;
receiving, by the plurality of activity components, information of a plurality of accounts from the plurality of interfaces respectively;
transferring, by the plurality of activity components respectively, the information of the plurality of accounts to corresponding service components in different processes via binding instances; and
performing, by the service components respectively, login according to the information of the accounts.
